(19) United States
(12) Patent Application Publication
(10) Pub. No.: US 2019/0090114 A1
(43) Pub. Date: Mar. 21, 2019

(54) Asset Tracking Device and Method of Use

(71) Applicant: Stanley G. Van Meter, II, Lake Mary, FL (US)

(72) Inventor: Stanley G. Van Meter, II, Lake Mary, FL (US)

(21) Appl. No.: 16/136,153

(22) Filed: Sep. 19, 2018

Related U.S. Application Data
(60) Provisional application No. 62/560,550, filed on Sep. 19, 2017.

(51) Int. Cl. H04W 4/80; G06Q 10/08; G06Q 10/00; G06Q 30/00; G06F 9/54; G06Q 50/10

(52) U.S. Cl. CPC H04W 4/80; G06Q 10/087; G06Q 10/0833; G06Q 50/10; G06Q 30/012; G06F 9/542; G06Q 10/20

(57) ABSTRACT

Asset tracking is accomplished, in real time, by attaching a BLE beacon or other tracking device to an asset. The beacon then provides real time asset security information by providing dynamic alerts and updates to the data cloud an connected web portals for management and tracking of the assets. Using the BLE beacons, a user accessing the SDAT data cloud via a web portal can locate any tagged asset in a facility from a mobile device, using a mobile application. This tracking and accountability provides improved inventory control and allocation. An advanced proximity marketing feature provides visual asset movements for powerful reporting

### CROSS REFERENCE TO RELATED APPLICATIONS

This application claims priority from U.S. patent application Ser. No. 62/560,550, entitled “Asset Tracking Device and Method of Use”, filed on Sep. 19, 2017. The benefit under 35 USC § 119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates in general to asset tracking. More specifically, the present invention relates to asset tracking using a beacon placed on an asset and a wireless network and wireless access devices.

### BACKGROUND OF THE INVENTION

In the past, people had to painstakingly update their assets' values using ledgers and spreadsheets.

Sometimes, an asset is needed immediately. Often times, the equipment hasn't been stored properly after it was used or it has been put on vehicle or other mobile device and its location is unsure.

Many companies have at least two warehouses. Other companies have large assets like fleets of service trucks that are stored outside. In both of these situations, RFID technology can help you find your asset, but the readers that work in warehouses aren't strong enough to find the assets in outdoor locations.

Therefore what is needed is an electronic, automated asset tracking device, software system, and method of use that provides automated asset tracking and provides exact, real time locations of the assets in a plurality of locations and on mobile platforms.

### SUMMARY OF THE INVENTION

The present invention is an asset tracking device and method of use. A BLUETOOTH low energy (BLE) beacon is attached to a plurality of assets, transforming them from static assets into tagged assets. The BLE beacons can interact with a SDAT data cloud by a BLUFI Gateway, WIFI network, or any wireless network. Additionally, the BLE beacon may use a cellular network to communicate with the SDAT data cloud via a mobile phone application. A management web portal also communicates with the SDAT data cloud and provides tracking information and other details for each BLE beacon in communication with the SDAT data cloud.

Asset tracking is accomplished, in real time, by attaching a BLE beacon or other tracking device to an asset. The beacon then provides real time asset security information by providing dynamic alerts and updates to the data cloud and connected web portals for management and tracking of the assets. Using the BLE beacons, a user accessing the SDAT data cloud via a web portal can locate any tagged asset in a facility from a mobile device, using a mobile application. This tracking and accountability provides improved inventory control and allocation. An advanced proximity marketing feature provides visual asset movements for powerful reporting.

The dual function technology enabled by the present invention leads to an increase in return on investment/inventory (ROI). Asset trackers are attached to any number of asset types and provide automated inventory monitoring. When an asset is sold, the beacon attached to the asset can be transferred to the receiver of the asset. The receiver, in possession of the tracker, tag, beacon, then can use it to receive benefits, such as warranty information, sales receipts, etc. This tracking and transfer to the receiver of an asset provides marketing opportunities for both the provider and receiver.

One embodiment of the present invention teaches the use of a BLE beacon or asset tracking device as a keychain. This keychain is what is used to track the devices and is then passed on to the member when the repair and asset is provided to them.

### Definitions

An “accelerometer” is a device that measures proper acceleration (“g-force”). Proper acceleration is not the same as coordinate acceleration (rate of change of velocity).

“Application software” or “software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. “Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

BLUETOOTH is a wireless technology standard for exchanging data over short distances (using short-wavelength UHF radio waves in the ISM band from 2.4 to 2.485 GHz) from fixed and mobile devices, and building personal area networks (PANs).

BLUETOOTH low energy (Bluetooth LE, BLE, marketed as BLUETOOTH SMART) is a wireless personal area network technology designed and marketed by the Bluetooth Special Interest Group aimed at novel applications in the healthcare, fitness, beacons, security, and home entertainment industries.

A compass is an instrument used for navigation and orientation that shows direction relative to the geographic cardinal directions, or “points”. Usually, a diagram called a compass rose, shows the directions north, south, east, and west as abbreviated initials marked on the compass.

“Electronic Mobile Device” is defined as any computer, phone, or computing device that is comprised of a battery, display, circuit board, and processor that is capable of processing or executing software. Examples of electronic mobile devices are smartphones, laptop computers, and table PCs.

The Global Positioning System (GPS) is a space-based navigation system that provides location and time information in all weather conditions, anywhere on or near the Earth where there is an unobstructed line of sight to four or more GPS satellites.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

A gyroscope is a spinning wheel or disc in which the axis of rotation is free to assume any orientation. When rotating, the orientation of this axis is unaffected by tilting or rotation of the mounting, according to the conservation of angular momentum. Because of this, gyroscopes are useful for measuring or maintaining orientation. Applications of gyroscopes include inertial navigation systems where magnetic compasses would not work (as in the Hubble telescope) or would not be precise enough (as in intercontinental ballistic missiles), or for the stabilization of flying vehicles like radio-controlled helicopters or unmanned aerial vehicles, and recreational boats and commercial ships.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

In telecommunications, received signal strength indicator (RSSI) is a measurement of the power present in a received radio signal. RSSI is usually invisible to a user of a receiving device. However, because signal strength can vary greatly and affect functionality in wireless networking, IEEE 802.11 devices often make the measurement available to users. RSSI is often done in the intermediate frequency (IF) stage before the IF amplifier. In zero-IF systems, it is done in the baseband signal chain, before the baseband amplifier. RSSI output is often a DC analog level. It can also be sampled by an internal ADC and the resulting codes available directly or via peripheral or internal processor bus.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

A “trip” is defined as the movement of a person from a starting point to an end point or destination. A trip may or may not include multiple stops of various lengths of time.

A “User” is any person registered to use the computer system executing the method of the present invention.

A “web application” or “web app” is any application software that runs in a web browser and is created in a browser-supported programming language (such as the combination of JavaScript, HTML and CSS) and relies on a web browser to render the application.

“Wi-Fi”, also spelled Wifi, WiFi, or wifi, is a local area wireless technology that allows an electronic device to exchange data or connect to the internet using 2.4 GHz UHF and 5 GHz SHF radio waves. The name is a trademark name, and is a play on the audiophile term Hi-Fi. The Wi-Fi Alliance defines Wi-Fi as any “wireless local area network (WLAN) products that are based on the Institute of Electrical and Electronics Engineers' (IEEE) 802.11 standards”.[1] However, since most modern WLANs are based on these standards, the term “Wi-Fi” is used in general English as a synonym for “WLAN”. Only Wi-Fi products that complete Wi-Fi Alliance interoperability certification testing successfully may use the “Wi-Fi CERTIFIED” trademark.

### BRIEF DESCRIPTION OF THE DRAWINGS

The accompanying drawings, which are incorporated herein form a part of the specification, illustrate the present invention and, together with the description, further explain the principles of the invention and to enable a person skilled in the pertinent art to make and use the invention.

FIG. 1 is a flow chart illustrating the solution architecture.

FIG. 2 a flow chart illustrating the usefulness of the asset tracking device and method of the present invention.

FIG. 3 is a flow chart illustrating one application of the asset tracking device and method of the present invention.

FIG. 4 is a flow chart illustrating the beacon life cycle.

FIG. 5 is an illustrative keychain device taught by the asset tracking device and method of the present invention.

FIG. 6 is a flow chart of services provided by the asset tracking device and method of the present invention.

FIG. 7 is a flow chart illustrating the improved driver safety as a result of implementation of the asset tracking device and method of the present invention.

FIG. 8 is a flow chart illustrating the improved proximity marketing as a result of implementation of the asset tracking device and method of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figure, it is possible to see the various major elements constituting the apparatus of the present invention.

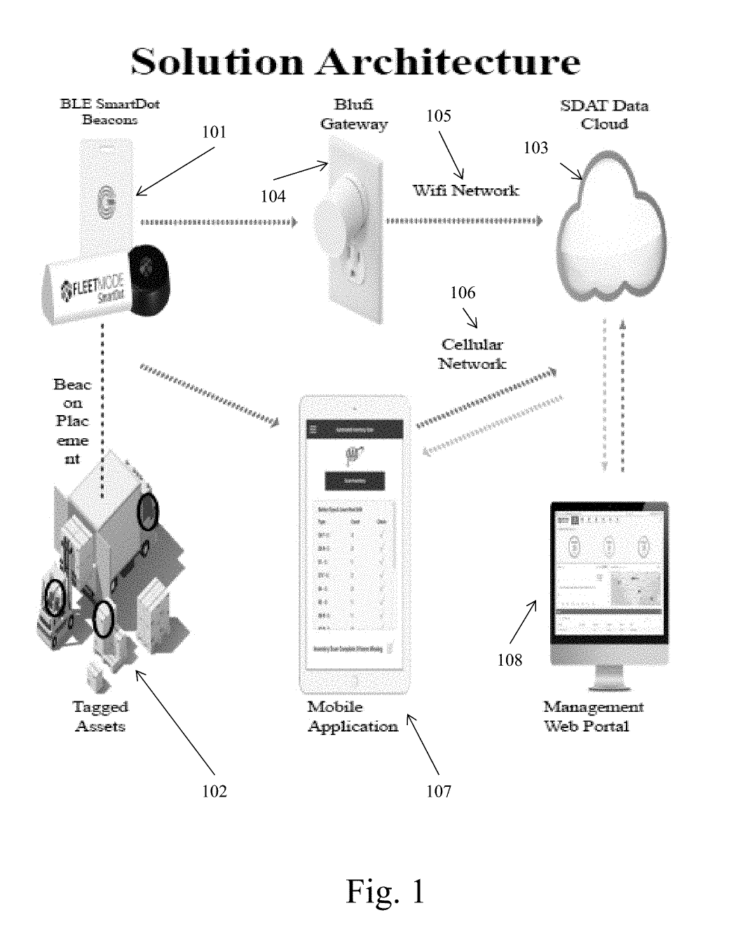

Now referring to FIG. 1, the embodiment of the asset tracking hardware and software are illustrated. A BLUETOOTH low energy (BLE) beacon 101 is attached to a plurality of assets 102, transforming them from static assets into tagged assets. The BLE beacons can interact with a SDAT data cloud 103 by a BLUFI Gateway 104, WIFI network 105, or any wireless network. Additionally, the BLE beacon 101 may use a cellular network 106 to communicate with the SDAT data cloud 103 via a mobile phone application 107. A management web portal 108 also communicates with the SDAT data cloud 103 and provides tracking information and other details for each BLE beacon 101 in communication with the SDAT data cloud 103.

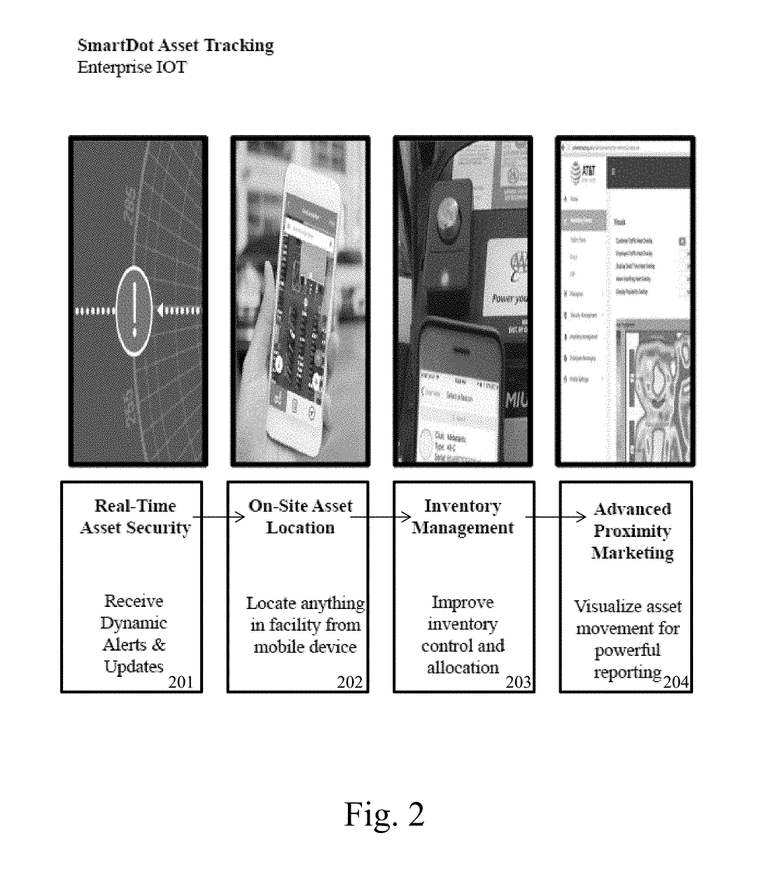

FIG. 2 a flow chart illustrating the usefulness of the asset tracking device and method of the present invention. Asset tracking is accomplished, in real time, by attaching a BLE beacon or other tracking device to an asset. The beacon then provides real time asset security information 201 by providing dynamic alerts and updates to the data cloud an connected web portals for management and tracking of the assets. Using the BLE beacons, a user accessing the SDAT data cloud via a web portal can locate any tagged asset in a facility from a mobile device 202, using a mobile application. This tracking and accountability provides improved inventory control and allocation 203. An advanced proximity marketing feature provides visual asset movements for powerful reporting 204.

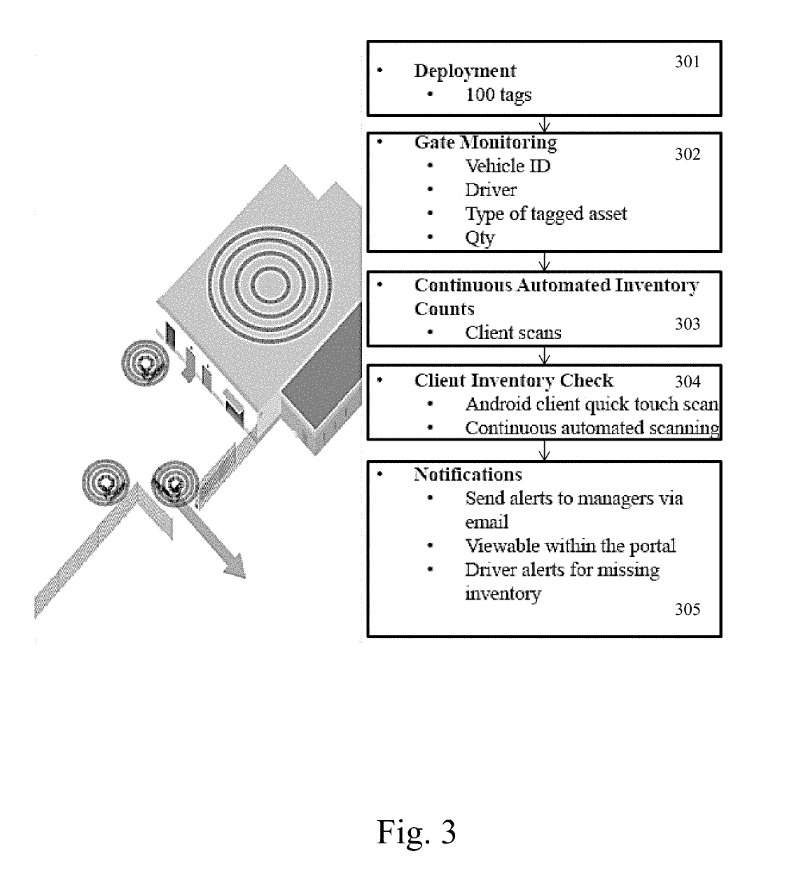

FIG. 3 is a flow chart illustrating one application of the asset tracking device and method of the present invention. In this embodiment, one hundred tags or asset trackers or beacons are fixed to assets 301. Gate monitoring tracks vehicle IDs, drives, and the types of tagged assets on each vehicle and the quantity 302. The system then uses this information to provide continuous automated inventory counts and client scans 303. Clients can run inventory checks using a touch screen on the mobile device as displayed by the mobile application or simply check the continuous automated scanning that is being tracked by the software 304. Notifications are sent to alert managers via email, text, or other automated communication 305. These communications are viewable within the portal. Drivers can also be alerted to missing inventory.

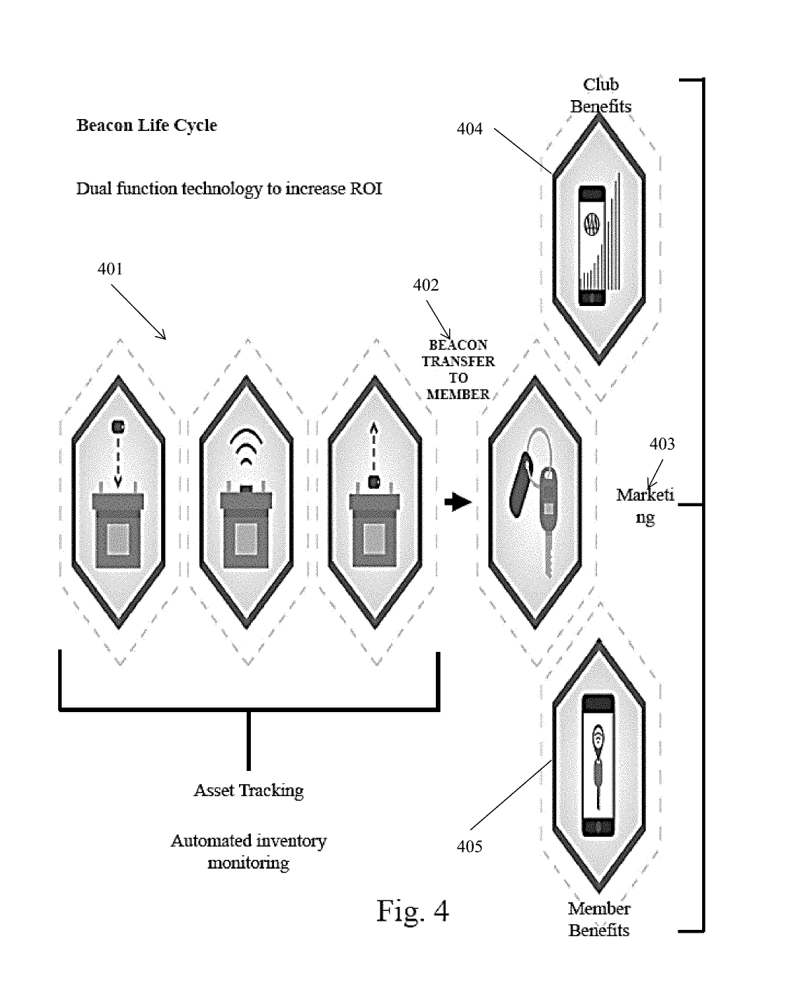

FIG. 4 is a flow chart illustrating the beacon life cycle. The dual function technology enabled by the present invention leads to an increase in return on investment/inventory (ROI). Asset trackers are attached to any number of asset types and provide automated inventory monitoring 401. When an asset is sold, the beacon attached to the asset can be transferred to the receiver of the asset 402. The receiver, in possession of the tracker, tag, beacon, then can use it to receive benefits, such as warranty information, sales receipts, etc. This tracking and transfer to the receiver of an asset provides marketing opportunities 403 for both the provider 404 and receiver 405.

In a specific embodiment, the present invention could have a plurality of automotive batteries or tires tagged with asset tracking beacons. This would then provide an automated inventory of battery types and locations, both at a warehouse or business location and on trucks as they leave for servicing. In the beacon transfer embodiment, this example extends to a member of an insurance policy or group that assists in roadside repairs, which are commonly tires and batteries.

When a truck is dispatched to assist a member, not only with the inventory be updated in real time, but managers can be sure that the dispatched truck has the proper/matching battery or tire, and its location and transit time. Once the repair is made and the asset, a tire or battery for example, is transferred to the receiver, here a member, the beacon is transferred to them as well.

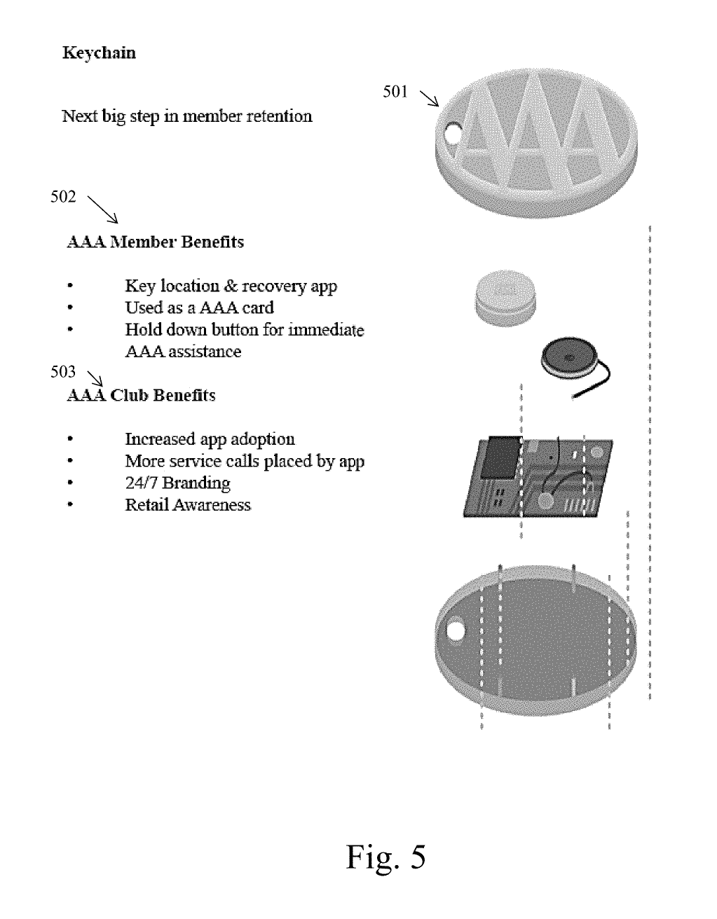

FIG. 5 is an illustrative keychain device 501 taught by the asset tracking device and method of the present invention. One embodiment of the present invention teaches the use of a BLE beacon or asset tracking device as a keychain 501. This keychain 501 is what is used to track the devices and is then passed on to the member when the repair and asset is provided to them.

Key benefits to a member 502 are access, using a keychain 501 embodiment are a key location and recover application provided for free, which allows a member, who has connected their keychain to their keys, to find them if they are lost. The keychain 501 can also be used as the member's membership card, and if provided with a button, it can provide a means of connect for assistance.

The benefits to the club or provider 503 are increased app adoption by its members, increased service call placed by the application, 24/7 branding, and retail awareness.

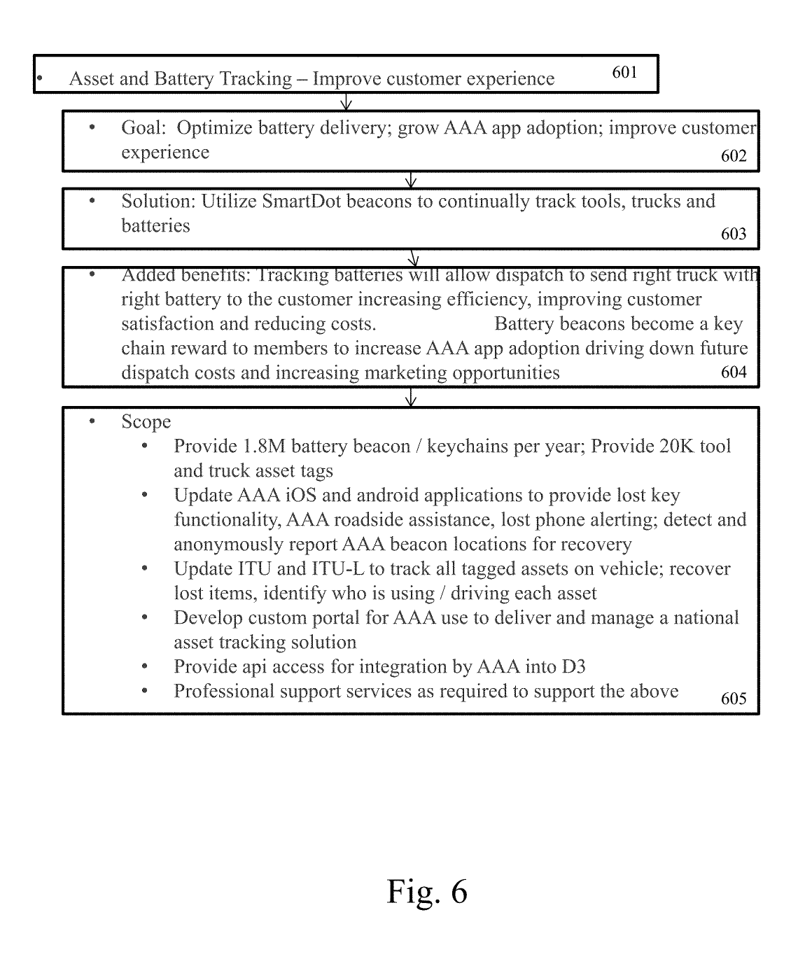

FIG. 6 is a flow chart of services provided by the asset tracking device and method of the present invention. The scope of Services include Asset/Battery Tracking 601. Asset and Battery Tracking results in an improved customer experience. The goal is to optimize battery delivery; grow app adoption; and improve customer experience 602.

The solution of the present invention is to utilize asset tracking beacons to continually track tools, trucks, and batteries 603. Added benefits: Tracking batteries will allow dispatch to send right truck with right battery to the customer increasing efficiency, improving customer satisfaction and reducing costs 604. Battery beacons become a key chain reward to members to increase AAA app adoption driving down future dispatch costs and increasing marketing opportunities.

In one embodiment, the scope of services 605, the devices will provide 1.8M battery beacon/keychains per year; and 20K tool and truck asset tags. Update applications to provide lost key functionality, roadside assistance, lost phone alerting; detect and anonymously report beacon locations for recovery. Update ITU and ITU-L to track all tagged assets on vehicle; recover lost items, identify who is using/driving each asset. Develop custom portal for use to deliver and manage a national asset tracking solution. Provide api access for integration into D3. Professional support services as required to support the above.

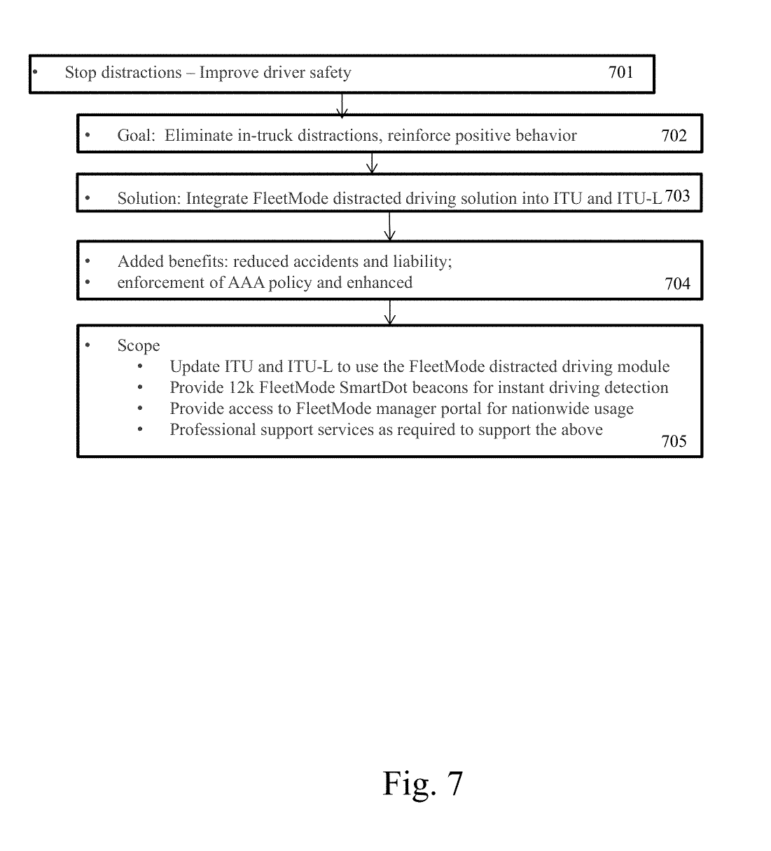

FIG. 7 is a flow chart illustrating the improved driver safety as a result of implementation of the asset tracking device and method of the present invention. The benefits of the present invention provide distracted driving prevention. The present invention stops distractions and improves driver safety 701. The goal is to eliminate in-truck distractions, reinforce positive behavior 702. The solution is to integrate a distracted driving solution into ITU and ITU-L 703. Added benefits: reduced accidents and liability; enforcement of policy and enhanced 704.

In one implementation, the present invention would be launched by providing an update ITU and ITU-L to use the distracted driving module. Provide 12 k FleetMode SmartDot beacons for instant driving detection. Provide access to FleetMode manager portal for nationwide usage and professional support services as required to support the above 705.

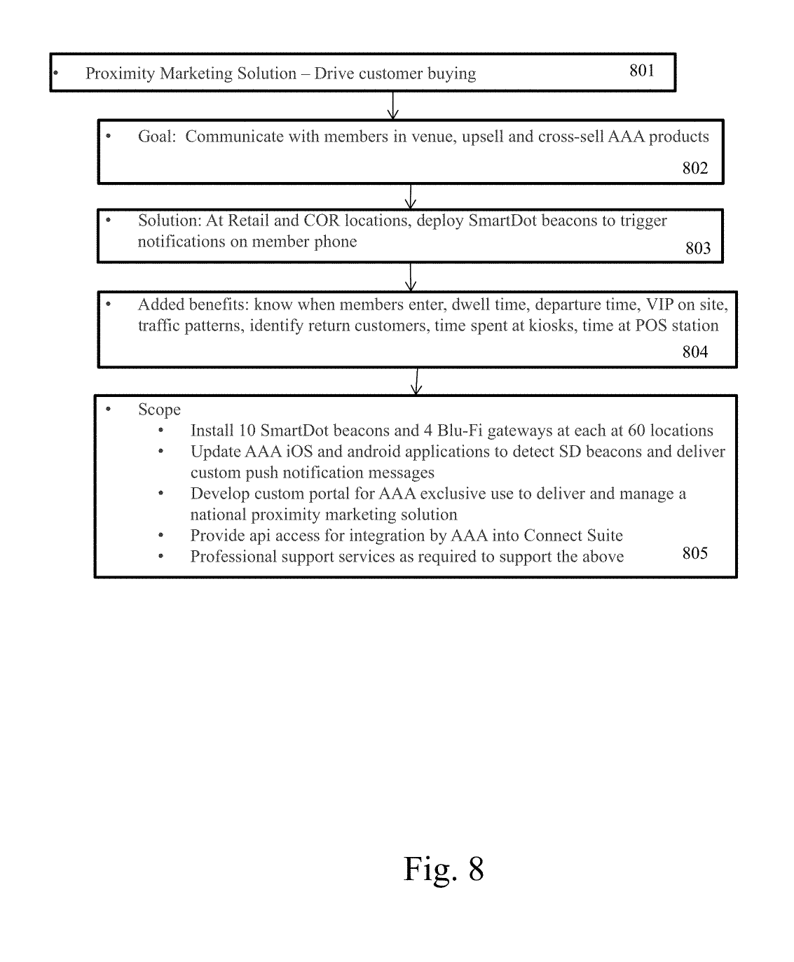

FIG. 8 is a flow chart illustrating the improved proximity marketing as a result of implementation of the asset tracking device and method of the present invention 801. With respect to the proximity marketing, the goal is to communicate with members in venue, upsell and cross-sell products 802. The solution: At Retail and COR locations, is to deploy beacons to trigger notifications on member phone. 803 Added benefits: know when members enter, dwell time, departure time, VIP on site, traffic patterns, identify return customers, time spent at kiosks, time at POS station 804.

Implementation of this embodiment would result in the install of 10 beacons and 4 Blu-Fi gateways at each at 60 locations. Update iOS and android applications to detect SD beacons and deliver custom push notification messages. Develop custom portal for exclusive use to deliver and manage a national proximity marketing solution. Provide api access for integration by into Connect Suite and professional support services as required to support the above 805.

The system is set to run on a computing device or mobile electronic device. A computing device or mobile electronic device on which the present invention can run would be comprised of a CPU, Hard Disk Drive, Keyboard, Monitor, CPU Main Memory and a portion of main memory where the system resides and executes. Any general-purpose computer, smartphone, or other mobile electronic device with an appropriate amount of storage space is suitable for this purpose. Computer and mobile electronic devices like these are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. An Asset Tracking Device and Method of Use comprising:
a BLUETOOTH low energy (BLE) beacon is attached to a plurality of assets, transforming them from static assets into tagged assets;
the BLE beacons can interact with an SDAT data cloud by a BLUFI Gateway, WIFI network, or any wireless network;
the BLE beacon may use a cellular network to communicate with the SDAT data cloud via a mobile phone application; and
a management web portal also communicates with the SDAT data cloud and provides tracking information and other details for each BLE beacon in communication with the SDAT data cloud.

2. The method of claim 1, wherein asset tracking is accomplished, in real time, by attaching a BLE beacon or other tracking device to an asset;
the beacon then provides real time asset security information by providing dynamic alerts and updates to the data cloud an connected web portals for management and tracking of the assets;
using the BLE beacons, a user accessing the SDAT data cloud via a web portal can locate any tagged asset in a facility from a mobile device, using a mobile application;
this tracking and accountability provides improved inventory control and allocation; and
an advanced proximity marketing feature provides visual asset movements for powerful reporting.

3. The method of claim 1, wherein
one hundred tags or asset trackers or beacons are fixed to assets;
gate monitoring tracks vehicle IDs, drives, and the types of tagged assets on each vehicle and the quantity;
the system then uses this information to provide continuous automated inventory counts and client scans;
clients can run inventory checks using a touch screen on the mobile device as displayed by the mobile application or simply check the continuous automated scanning that is being tracked by the software. Notifications are sent to alert managers via email, text, or other automated communication;
these communications are viewable within the portal; and
drivers can also be alerted to missing inventory.

4. The method of claim 1, wherein
asset trackers are attached to any number of asset types and provide automated inventory monitoring;
when an asset is sold, the beacon attached to the asset can be transferred to the receiver of the asset;
the receiver, in possession of the tracker, tag, beacon, then can use it to receive benefits, such as warranty information, sales receipts, etc.; and
this tracking and transfer to the receiver of an asset provides marketing opportunities for both the provider and receiver.

5. The method of claim 3, wherein
have a plurality of automotive batteries or tires tagged with asset tracking beacons; and
this would then provide an automated inventory of battery types and locations, both at a warehouse or business location and on trucks as they leave for servicing.

6. The method of claim 5, wherein
when a truck is dispatched to assist a member, not only with the inventory be updated in real time, but managers can be sure that the dispatched truck has the proper/matching battery or tire, and its location and transit time; and
once the repair is made and the asset, a tire or battery for example, is transferred to the receiver, here a member, the beacon is transferred to them as well.

7. The method of claim 6, wherein
a keychain device taught by the asset tracking device and method of the present invention; and
the keychain is what is used to track the devices and is then passed on to the member when the repair and asset is provided to them.

8. The method of claim 7, wherein
key benefits to a member are access, using a keychain embodiment are a key location and recover application provided for free, which allows a member, who has connected their keychain to their keys, to find them if they are lost; and
the keychain can also be used as the member's membership card, and if provided with a button, it can provide a means of connect for assistance.

9. The method of claim 8, wherein
the benefits to the club or provider are increased app adoption by its members, increased service call placed by the application, 24/7 branding, and retail awareness.

10. The method of claim 3, wherein
the solution of the present invention is to utilize asset tracking beacons to continually track tools, trucks, and batteries.

11. The method of claim 10, wherein
tracking batteries will allow dispatch to send right truck with right battery to the customer increasing efficiency, improving customer satisfaction and reducing costs.

11. The method of claim 10, wherein
battery beacons become a key chain reward to members to increase AAA app adoption driving down future dispatch costs and increasing marketing opportunities.

12. The method of claim 3, wherein
providing 1.8M battery beacon/keychains per year;
20K tool and truck asset tags;
update applications to provide lost key functionality, roadside assistance, lost phone alerting; detect and anonymously report beacon locations for recovery;
update ITU and ITU-L to track all tagged assets on vehicle; recover lost items, identify who is using/driving each asset;
develop custom portal for use to deliver and manage a national asset tracking solution; and
provide api access for integration into D3. Professional support services as required to support the above.

13. The method of claim 12, wherein
providing an update ITU and ITU-L to use the distracted driving module;
provide 12 k FleetMode SmartDot beacons for instant driving detection; and
provide access to FleetMode manager portal for nationwide usage and professional support services as required to support the above.

14. The method of claim 13, wherein
the goal is to communicate with members in venue, upsell and cross-sell products.

15. The method of claim 14, wherein
at Retail and COR locations, is to deploy beacons to trigger notifications on member phone; and
added benefits: know when members enter, dwell time, departure time, VIP on site, traffic patterns, identify return customers, time spent at kiosks, time at POS station.

16. The method of claim 15, wherein
implementation of this embodiment would result in the install of 10 beacons and 4 Blu-Fi gateways at each at 60 locations;
Update iOS and android applications to detect SD beacons and deliver custom push notification messages;
develop custom portal for exclusive use to deliver and manage a national proximity marketing solution; and
provide api access for integration by into Connect Suite and professional support services as required to support the above.
